(19) United States
(12) Patent Application Publication
(10) Pub. No.: US 2011/0001762 A1
(43) Pub. Date: Jan. 6, 2011

(54) METHOD FOR ADJUSTING DISPLAYED FRAME, ELECTRONIC DEVICE, AND COMPUTER READABLE MEDIUM THEREOF

(75) Inventors: Li Li, Shanghai City (CN); Liang Huang, Shanghai City (CN); Tony Tsai, Taipei (TW)

Correspondence Address: J C PATENTS, 4 VENTURE, SUITE 250, IRVINE, CA, 92618, US

(73) Assignee: INVENTEC APPLIANCES CORP., Taipei (TW)

(21) Appl. No.: 12/819,407

(22) Filed: Jun. 21, 2010

(30) Foreign Application Priority Data
Jul. 2, 2009 (TW) 98122431

(51) Int. Cl. G09G 5/00; G06K 9/00

(52) U.S. Cl. 345/649; 382/103

(57) ABSTRACT

A method for adjusting a displayed frame, an electronic device, and a computer readable medium thereof are provided. In the present method, a connection line between both eyes of a user is obtained. Then, a relation between the connection line and a screen of the electronic device is calculated. Finally, a frame currently displayed on the screen is rotated according to the relation, and the rotated frame is displayed on the screen. Thereby, the frame is automatically adjusted to an angle most suitable for the user without any action performed by the user on the electronic device.

### CROSS-REFERENCE TO RELATED APPLICATION

This application claims the priority benefit of Taiwan application serial no. 98122431, filed on Jul. 2, 2009. The entirety of the above-mentioned patent application is hereby incorporated by reference herein and made a part of specification.

### BACKGROUND OF THE INVENTION

1. Field of the Invention

The present invention generally relates to a method for adjusting a frame, and more particularly, to a method for adjusting the display direction of a frame according to the eye movement of a user.

2. Description of Related Art

Electronic devices of different types and functions have been developed along with the development of technologies. Besides cell phones, personal digital assistants (PDAs), and computers, digital photo frames and electronic books have been gradually accepted by today's consumers.

Generally speaking, an electronic device with a screen for displaying frames is usually provided with a function of adjusting the display direction of the frames, and there are two different types of adjusting techniques. According to the first type of technique, the display direction of a frame is adjusted when a user presses down a specific key on the electronic device. According to the other technique, the display direction of an frame is adjusted through a dynamic sensor device disposed in the electronic device, wherein the dynamic sensor device senses a dynamic change on the electronic device caused by an action (for example, a rotating action) performed by a user on the electronic device, and the display direction of the frame is then adjusted according to the dynamic change.

However, either of foregoing two adjusting techniques adjusts the display direction of a frame after a user performs an action on the electronic device but cannot automatically deduce the feeling of the user or adjust the display direction of the frame in real time.

### SUMMARY OF THE INVENTION

Accordingly, the present invention is directed to a method for adjusting a displayed frame, wherein the frame can be adjusted to an angle most suitable for a user.

The present invention is directed to an electronic device that detects the position of a user's eyes and adjusts a displayed frame accordingly.

The present invention provides a method suitable for adjusting a frame displayed on a screen of an electronic device. In the present method, first, a connection line between both eyes of a user is obtained. Then, a relation between the connection line and the screen is calculated. Finally, the frame is rotated according to the relation, and the rotated frame is displayed on the screen.

The present invention also provides an electronic device including a screen, an eye detection module, a calculation module, and an adjustment module. The screen is configured to display a frame. The eye detection module is configured to obtain a connection line between both eyes of a user. The calculation module is connected to the eye detection module and the screen. The calculation module is configured to calculate a relation between the connection line and the screen. The adjustment module is connected to the calculation module and the screen. The adjustment module is configured to rotate the frame according to the relation and control the screen to display the rotated frame.

The present invention further provides a computer readable medium including a plurality of program instructions. The program instructions are suitable for being loaded into an electronic device having a screen to execute operations of tracking a movement information of eyes of a user through an eye gaze tracking technique, calculating a connection line according to the movement information, defining a baseline of the screen, calculating a relation between the connection line and the baseline, and rotating a frame currently displayed on the screen according to the relation, and displaying the rotated frame on the screen. In which, the baseline comprises at least one of a horizontal screen edge, a vertical screen edge, a screen internal horizontal line, and a screen internal vertical line.

As described above, in the present invention, whether the viewing angle of a user on a frame displayed on a screen has changed is determined through the detection of the user's eyes and an eye gaze tracking technique, and correspondingly the frame is adjusted to an angle most suitable for the user. Because the frame displayed on the screen of the electronic device can be automatically adjusted along with the viewing angle of the user, a best viewing effect can be achieved through the screen without any action performed by the user on the electronic device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of an electronic device according to an embodiment of the present invention.

FIG. 2 is a flowchart of a method for adjusting a displayed frame according to an embodiment of the present invention.

FIG. 3 is a diagram of a screen of an electronic device according to an embodiment of the present invention.

FIG. 4A is a top view illustrating that a user looks at a screen according to an embodiment of the present invention.

FIG. 4B and FIG. 4D are rear views illustrating that a user looks at a screen according to an embodiment of the present invention.

FIGS. 4C, 4E, 5A, and 5B are diagrams illustrating frames displayed on a screen according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

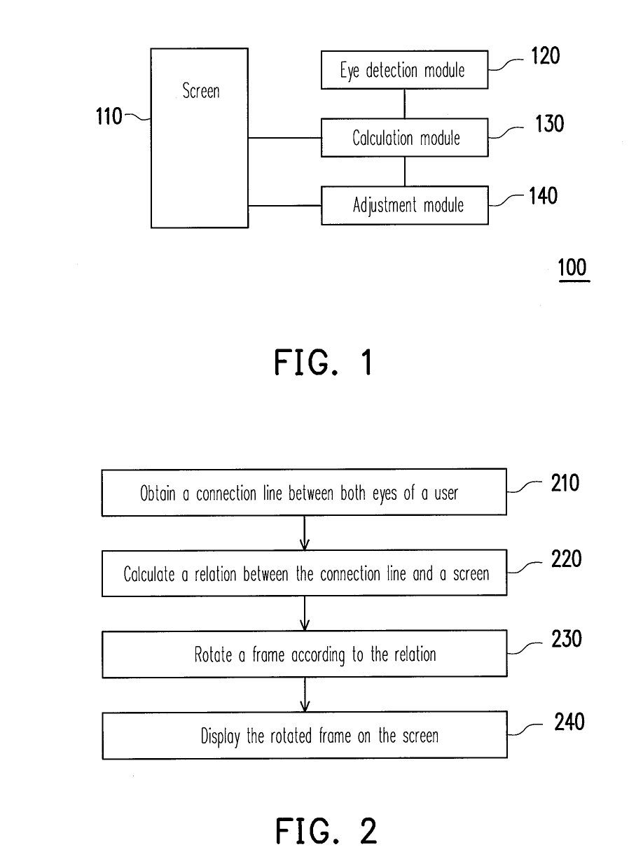

FIG. 1 is a block diagram of an electronic device according to an embodiment of the present invention. Referring to FIG. 1, the electronic device 100 includes a screen 110, an eye detection module 120, a calculation module 130, and an adjustment module 140. The electronic device 100 may be any device capable of displaying frames through its screen, such as an electronic book, a cell phone, a personal digital assistant (PDA), or a computer system. However, the type of the electronic device 100 is not limited herein.

The screen 110 may be a liquid crystal screen or a touch screen. The screen 110 displays a frame, and herein the content of the frame is not limited. The eye detection module 120 may be a human eye detection chip, software and hardware devices for realizing an eye gaze tracking technique, or a combination of foregoing devices. The eye detection module 120 obtains a connection line between both eyes of a user of the electronic device 100. The calculation module 130 is electronically connected to the eye detection module 120 and the screen 110. The calculation module 130 calculates a relation between the connection line and the screen 110. The adjustment module 140 is electronically connected to the calculation module 130 and the screen 110. The adjustment module 140 rotates the frame according to the relation and controls the screen 110 to display the rotated frame. In the present embodiment, the calculation module 130 and the adjustment module 140 may be hardware devices, software devices, or a combination of hardware and software devices that come with calculating and processing capabilities.

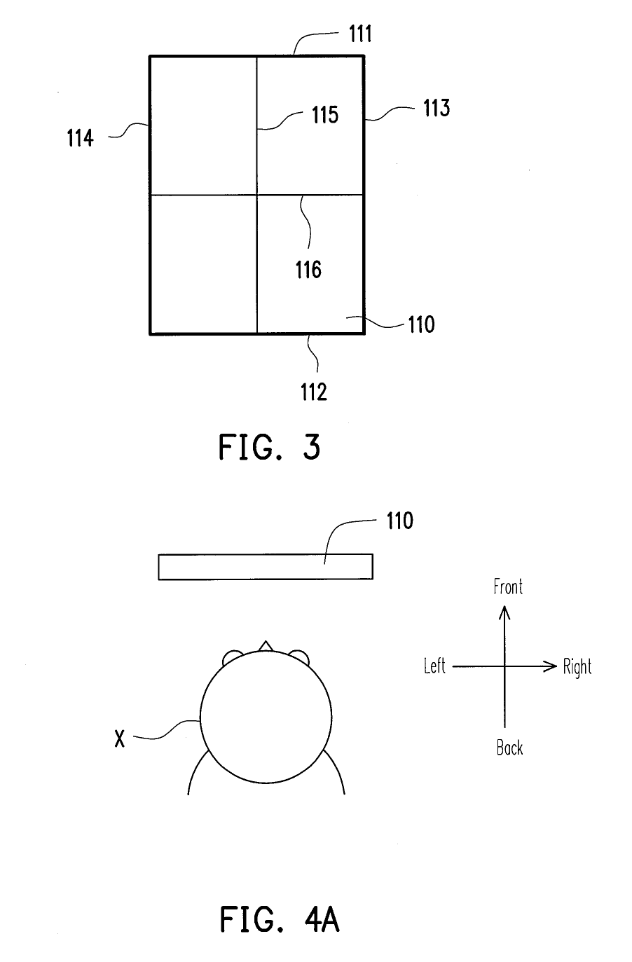

The operations of different components in the electronic device 100 will be explained below with reference to another embodiment of the present invention, wherein the steps of adjusting a displayed frame will be described in detail. FIG. 2 is a flowchart of a method for adjusting a displayed frame according to an embodiment of the present invention. Referring to both FIG. 1 and FIG. 2, when a user starts to view the frame displayed by the electronic device 100, first, in step 210, a connection line between both eyes of the user is obtained by the the eye detection module 120. For example, the eye detection module 120 tracks the movement information of the eyes of the user through an eye gaze tracking technique and calculates the connection line according to the movement information. The eye gaze tracking technique may track the movement information by detecting and determining the eye gaze direction through image analysis. In addition, the eye gaze tracking technique may also calculate the position offset of a same pupil feature point in two consecutive images as the movement information of the user's eyes. Moreover, the eye gaze tracking technique may further track the movement information according to the positions and the shapes of the pupils or the eye sockets or the eye gaze direction. However, the implementation of the eye gaze tracking technique is not limited herein.

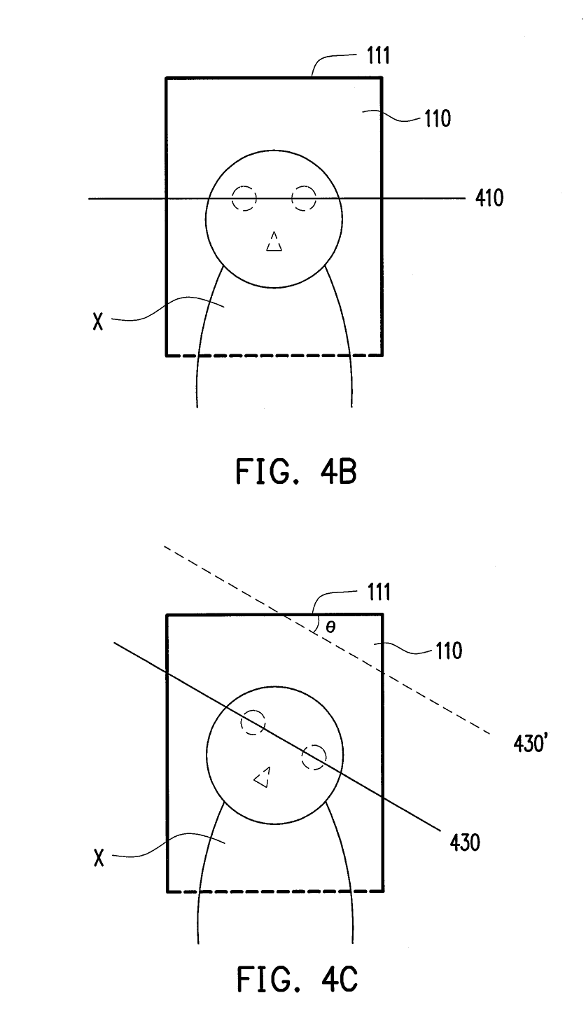

Then, in step 220, a relation between the connection line and the screen 110 is calculated by the calculation module 130. In the present embodiment, the relation between the connection line and the screen 110 refers to the angle formed by the projection of the connection line on the screen 110 and a baseline of the screen 110. Thus, while calculating the relation, the calculation module 130 first defines the baseline of the screen 110, then obtains the projection of the connection line on the screen 110, and finally calculates the angle formed by the connection line and the baseline. FIG. 3 is a diagram of the screen 110. The baseline of the screen 110 may be a horizontal screen edge (for example, the upper screen edge 111 or the lower screen edge 112), a vertical screen edge (for example, a left screen edge 114 and a right screen edge 113), a screen internal horizontal line 116 in the screen 110, or a screen internal vertical line 115 in the screen 110. It should be noted that the positions of the screen internal horizontal line and the screen internal vertical line are not limited herein. In other words, the screen internal horizontal line may be the horizontal median or any horizontal line in the screen 110, and the screen internal vertical line may be the vertical median or any vertical line in the screen 110. For the convenience of description, the baseline of the screen 110 is assumed to be the upper edge 111 of the screen 110 in following embodiments.

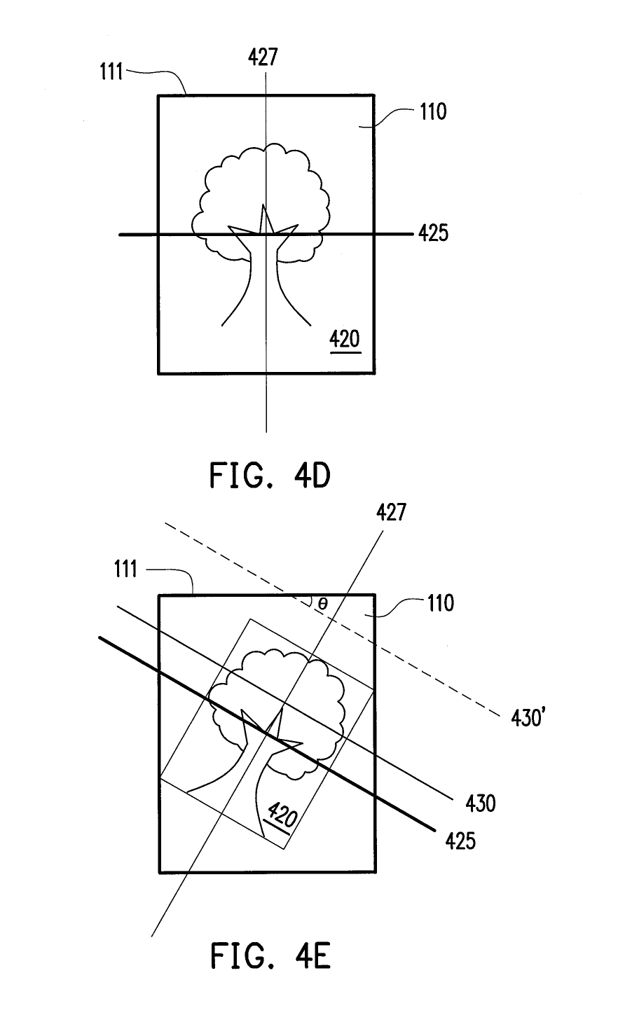

Below, how the calculation module 130 calculates the relation between the connection line and the screen 110 (i.e. the angle formed by the projection of the connection line on the screen 110 and the baseline) will be further described. FIG. 4A is a top view illustrating that a user X views a frame displayed on the screen 110 by directly facing the screen 110 and without turning his head, and FIG. 4B is a rear view of the situation illustrated in FIG. 4A. As shown in FIG. 4B, in such a situation, the projection of the connection line 410 (between both eyes of the user X) on the screen 110 obtained by the eye detection module 120 is parallel to the baseline of the screen 110 (i.e., the upper edge 111). When the user X tilts his head rightwards (as shown in FIG. 4C), the eye detection module 120 obtains the current connection line 430 of the user X. When the calculation module 130 calculates the angle formed by the projection of the connection line 430 on the screen 110 and the upper edge 111, it may move the projection of the connection line 430 on the screen 110 to a position crossing the upper edge 111 (the moved connection line 430 is indicated by the line 430′) so as to obtain the angle θ.

Next, in step 230, the frame currently displayed on the screen 110 is rotated by the adjustment module 140 according to the relation obtained by the calculation module 130. Namely, the adjustment module 140 rotates the frame displayed on the screen 110 according to the angle formed by the projection of the connection line on the screen 110 and the baseline. To be specific, the adjustment module 140 may rotate the frame by transforming the frame into an image and then rotating the image according to the angle. In an embodiment, the adjustment module 140 rotates the frame according to the angle in real time. While in another embodiment, the adjustment module 140 only rotates the frame according to the angle when the angle is greater than a predetermined value. The predetermined value may be any value between 20° and 30°. However, the present invention is not limited thereto. For the convenience of description, it is assumed that the adjustment module 140 only rotates the frame according to the angle when the angle is greater than a predetermined value in following embodiments.

For example, when the adjustment module 140 rotates the frame, it first defines a horizontal line in the frame, and when the angle is greater than the predetermined value, rotates the frame according to the angle until the horizontal line in the frame is parallel to the connection line. Besides, when the adjustment module 140 rotates the frame, it may also first define a vertical line in the frame, and when the angle is greater than the predetermined value, rotate the frame according to the angle until the vertical line is perpendicular to the projection of the connection line on the screen 110.

When the user X faces directly to the screen 110 and does not tilt his head (as shown in FIG. 4B), the frame displayed on the screen 110 is as the frame 420 in FIG. 4D. In FIG. 4D, the lines 425 and 427 are respectively the horizontal line and the vertical line of the frame 420 defined by the adjustment module 140. When the user X tilts his head as shown in FIG. 4C and the angle θ is formed by the projection of the connection line 430 on the screen 110 and the baseline (i.e., the upper edge 111), the adjustment module 140 rotates the frame 420 for the angle θ so that the horizontal line 425 in the frame 420 is parallel to the connection line 430 (the horizontal line 425 is also parallel to the line 430′), as shown in FIG. 4E. Additionally, when the user X tilts his head as shown in FIG. 4C, the adjustment module 140 may also rotate the frame 420 for the angle θ so that the vertical line 427 of the frame 420 is perpendicular to the projection of the connection line 430 on the screen 110 (the vertical line 427 is also perpendicular to the line 430′), as shown in FIG. 4E.

In order to ensure that the adjusted frame 420 does not exceed the range of the screen 110, the adjustment module 140 obtains the aspect ratio of the frame 420 and the size of the screen 110 before the adjustment. When the angle is greater than the predetermined value and the frame is rotated according to the angle, the adjustment module 140 scales the frame 420 according to the aspect ratio and the size so as to allow the rotated frame 420 to be completely displayed on the screen 110 and keep the same aspect ratio.

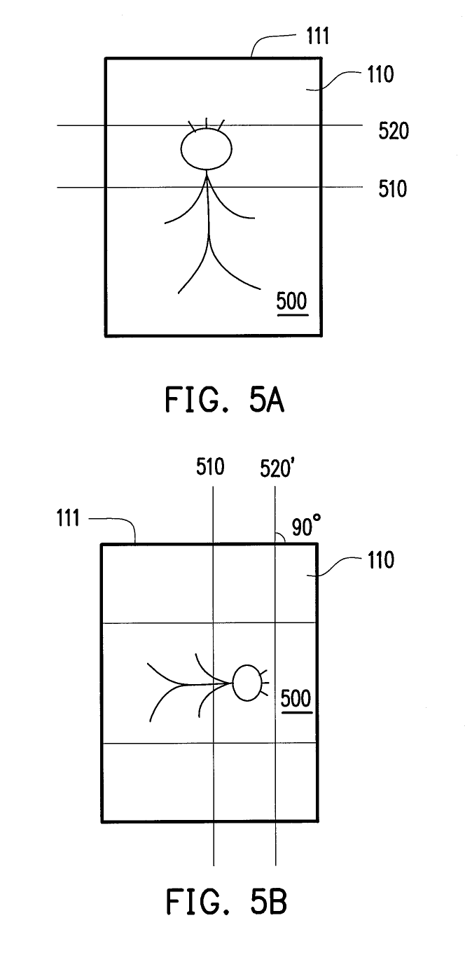

For example, assuming that the user faces the screen 110 directly and his head does not tilt or rotate, the frame displayed on the screen 110 is as the frame 500 illustrated in FIG. 5A. In FIG. 5A, the horizontal line 510 is determined as the horizontal line of the frame 500 by the adjustment module 140, and the connection line 520 is determined as the connection line between the eyes of the user by the eye detection module 120. Herein the connection line 520 is parallel to the baseline of the screen (i.e., the upper edge 111). However, when the user tilts his head so that an angle of 90° is formed by the projection of the connection line 520′ on the screen 110 and the upper edge 111, the frame 500 is rotated as shown in FIG. 5B, wherein the frame 500 has the same aspect ratio before and after the rotation.

Finally, in step 240 illustrated in FIG. 2, the adjustment module 140 controls the screen 110 to display the rotated frame to finish the entire procedure of adjusting the displayed frame. As described above, regardless of the content of the frame (text or pictures), through the operations of the eye detection module 120, the calculation module 130, and the adjustment module 140, the content of the frame is automatically adjusted along with the viewing angle of the user, so that the frame is always displayed at a most suitable angle for the user and the user can view the content of the frame comfortably without performing any action on the electronic device 100.

The present invention further provides a computer readable medium composed of a plurality of program instructions (for example, configuration program instructions or deployment program instructions). These program instructions can be loaded into an electronic device with a screen and executed by the same to execute various steps of the method for adjusting a displayed frame described above and allow the electronic device to achieve functions described in foregoing embodiments.

As described above, the embodiments of the present invention provide a method for adjusting a displayed frame, an electronic device, and a computer readable medium thereof, wherein when a user looks at a screen of the electronic device, an angle formed by the projection of a connection line between both eyes of the user on the screen and the screen is detected through eye detection and eye gaze tracking techniques, and a frame displayed on the screen is adjusted correspondingly. Thus, when the user looks at the frame displayed on the screen, the frame can be automatically adjusted to an angle most suitable for the user without any action performed by the user on the electronic device. Thereby, the comfort and convenience in using the electronic device are greatly improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adjusting a frame displayed on a screen of an electronic device, comprising:
obtaining a connection line between both eyes of a user;
calculating a relation between the connection line and the screen; and
rotating the frame according to the relation and displaying the rotated frame on the screen.

2. The method according to claim 1, wherein the step of obtaining the connection line comprises:
tracking a movement information of the eyes of the user through an eye gaze tracking technique; and
calculating the connection line according to the movement information.

3. The method according to claim 1, wherein the step of calculating the relation between the connection line and the screen comprises:
defining a baseline of the screen; and
calculating the relation between the connection line and the baseline.

4. The method according to claim 3, wherein the baseline comprises at least one of a horizontal screen edge, a vertical screen edge, a screen internal horizontal line, and a screen internal vertical line.

5. The method according to claim 3, wherein the relation is an angle formed by a projection of the connection line on the screen and the baseline.

6. The method according to claim 5, wherein the step of rotating the frame according to the angle comprises:
defining a horizontal line in the frame; and
when the angle is greater than a predetermined value, rotating the frame according to the angle until the horizontal line is parallel to the connection line.

7. The method according to claim 5, wherein the step of rotating the frame according to the angle comprises:
defining a vertical line in the frame; and
when the angle is greater than a predetermined value, rotating the frame according to the angle until the vertical line is perpendicular to the projection of the connection line on the screen.

8. The method according to claim 5, wherein the step of rotating the frame according to the angle comprises:
obtaining an aspect ratio of the frame;
obtaining a size of the screen; and
when the angle is greater than a predetermined value and the frame is rotated according to the angle, scaling the frame according to the aspect ratio and the size so as to allow the rotated frame to keep the same aspect ratio.

9. The method according to claim 5, wherein the step of rotating the frame according to the angle comprises:
transforming the frame into an image; and
when the angle is greater than a predetermined value, rotating the image as the rotated frame according to the angle.

10. An electronic device, comprising:
a screen used for displaying a frame;
an eye detection module used for obtaining a connection line between both eyes of a user;
a calculation module, coupled to the eye detection module and the screen, used for calculating a relation between the connection line and the screen; and
an adjustment module, coupled to the calculation module and the screen, used for rotating the frame according to the relation and controlling the screen displaying the rotated frame.

11. The electronic device according to claim 10, wherein the eye detection module tracks a movement information of the eyes of the user through an eye gaze tracking technique and calculates the connection line according to the movement information.

12. The electronic device according to claim 10, wherein the calculation module defines a baseline of the screen and calculates the relation between the connection line and the baseline.

13. The electronic device according to claim 12, wherein the baseline comprises at least one of a horizontal screen edge, a vertical screen edge, a screen internal horizontal line, and a screen internal vertical line.

14. The electronic device according to claim 12, wherein the relation is an angle formed between a projection of the connection line on the screen and the baseline, and the adjustment module rotates the frame according to the angle and controls the screen to display the rotated frame when the angle is greater than a predetermined value.

15. The electronic device according to claim 14, wherein the adjustment module defines a horizontal line in the frame and rotates the frame according to the angle until the horizontal line is parallel to the connection line when the angle is greater than a predetermined value.

16. The electronic device according to claim 14, wherein the adjustment module defines a vertical line in the frame and rotates the frame according to the angle until the vertical line is perpendicular to the projection of the connection line on the screen when the angle is greater than a predetermined value.

17. The electronic device according to claim 14, wherein the adjustment module obtains an aspect ratio of the frame, obtains a size of the screen, and scales the frame according to the aspect ratio and the size so as to allow the rotated frame to keep the same aspect ratio when the angle is greater than a predetermined value and the frame is rotated according to the angle.

18. The electronic device according to claim 14, wherein the adjustment module transforms the frame into an image and rotates image as the rotated frame according to the angle when the angle is greater than a predetermined value.

19. A computer readable medium storing a computer program comprising a plurality of program instructions, wherein the program instructions are suitable for being loaded into an electronic device having a screen to execute operations of:
tracking a movement information of eyes of a user through an eye gaze tracking technique;
calculating a connection line according to the movement information;
defining a baseline of the screen;
calculating a relation between the connection line and the baseline; and
rotating a frame currently displayed on the screen according to the relation, and displaying the rotated frame on the screen;
wherein the baseline comprises at least one of a horizontal screen edge, a vertical screen edge, a screen internal horizontal line, and a screen internal vertical line.

20. The computer readable medium according to claim 19, wherein the relation is an angle formed by a projection of the connection line on the screen and the baseline, and the operation of rotating the frame according to the angle in the method for adjusting the displayed frame comprises:
defining a horizontal line or a vertical line in the frame;
when the horizontal line is defined and the angle is greater than a predetermined value, rotating the frame according to the angle until the horizontal line is parallel to the connection line; and
when the vertical line is defined and the angle is greater than a predetermined value, rotating the frame according to the angle until the vertical line is perpendicular to the projection of the connection line on the screen.
